(19) United States
(12) Patent Application Publication
(10) Pub. No.: US 2013/0182550 A1
(43) Pub. Date: Jul. 18, 2013

(54) OPTICAL PICKUP APPARATUS

(71) Applicant: Minoru SATO, Ota-shi (JP)

(72) Inventor: Minoru SATO, Ota-shi (JP)

(73) Assignee: SANYO ELECTRIC CO., LTD., Moriguchi City (JP)

(21) Appl. No.: 13/554,061

(22) Filed: Jul. 20, 2012

(30) Foreign Application Priority Data
Jul. 22, 2011 (JP) 2011-161242

(51) Int. Cl. G11B 7/1362

(52) U.S. Cl. CPC G11B 7/1362
USPC 369/112.21

(57) ABSTRACT

An optical pickup apparatus includes: a laser light source to emit a laser beam; an object lens to irradiate an optical recording medium with the laser beam; a photodetector to receive a reflected light of the laser beam reflected by the optical recording medium; a semitransparent mirror interposed on an optical path between the laser light source and the object lens, to reflect the laser beam in a direction of the object lens and transmit it in a direction of the photodetector; and an astigmatism adding member interposed on an optical path between the semitransparent mirror and the photodetector, to add astigmatism to the reflected light, wherein the astigmatism adding member includes control film having first transmittance for polarization component in first direction contained in the reflected light is substantially equal to second transmittance for polarization component in second direction perpendicular to the first direction contained in the reflected light.

### CROSS-REFERENCE TO RELATED APPLICATION

This application claims the benefit of priority to Japanese Patent Application No. 2011-161242, filed Jul. 22, 2011, of which full contents are incorporated herein by reference.

### BACKGROUND OF THE INVENTION

1. Field of the Invention

The present invention relates to an optical pickup apparatus that performs an operation of reading out signals recorded on an optical recording medium and an operation of recording signals on an optical recording medium.

2. Description of the Related Art

Among optical pickup apparatuses that optically records and reproduces signals on an optical recording medium such as an optical disc of DVD (Digital Versatile Disc) or CD (Compact Disc) using a laser beam, there is known a single-unit optical pickup apparatus designed to handle DVDs and CDs of different recording densities.

An optical pickup apparatus compatible with such DVDs and CDs employs a multi-laser unit including a first laser light source configured to emit a laser beam of a red wavelength band from 645 nm to 675 nm compatible with DVDs and a second laser light source configured to emit a laser beam of a infrared wavelength band from 765 nm to 805 nm compatible with CDs and switches the laser beam to be used depending on the optical disc.

The DVD- and CD-compatible optical pickup apparatus uses a single object lens with an annular diffracting grating formed on its incidence plane and diffracts each of the laser beams of wavelengths compatible with DVD and CD optical discs with a diffraction grating so that spherical aberration is corrected for each optical disc to ensure the quality of the laser beam irradiated on each optical disc.

The DVD- and CD-compatible optical pickup apparatus achieves a simplified optical path by employing the above described laser unit compatible with two wavelengths and a single object lens.

Such an optical pickup apparatus is configured to have arranged on the optical path, for example, a laser diode, a half-wavelength plate, a diffraction grating, a semitransparent mirror, a monitoring photodetector, a collimator lens, a quarter-wavelength plate, a rise-up mirror, an object lens, an AS (AStigmatism) plate, and a photodetector.

The laser diode radiates a laser beam in the red wavelength band between 645 nm and 675 nm and a laser beam in the infrared wavelength band between 765 nm and 805 nm.

The half-wavelength plate converts a laser beam radiated from the laser diode and reflected by the semitransparent mirror to a linearly-polarized light in the S direction relative to the reflection plane of the semitransparent mirror.

The diffraction grating diffracts the laser beam, separating it into a main beam of a 0-order light and two sub-beams of +1-order light and −1-order light.

The semitransparent mirror is arranged tilted by 45 degrees with respect to the light axis of the laser beam, at a position where the laser beam transmitted through the diffraction grating enters, and is provided thereto a control film that reflects much of the laser beam converted to an S-polarized light by the half-wavelength plate and transmits therethrough much of the laser beam polarized in the P direction.

The monitoring photodetector is disposed at a position at which, among the laser beams radiated from the laser diode, the laser beam transmitted through the control film of the semitransparent mirror is irradiated and detects the intensity of the laser beam transmitted through the control film of the semitransparent mirror. A detection signal output from the monitoring photodetector is used to control the output of the laser beam radiated from the laser diode.

The collimator lens, disposed at a position where the laser beam reflected by the control film of the semitransparent mirror enters, converts the incoming laser beam to parallel light.

The quarter-wavelength plate is disposed at a position where the laser beam converted to a parallel light by the collimator lens enters. The quarter-wavelength plate converts a linearly-polarized light to a circularly-polarized light or conversely, a circularly-polarized light to a linearly-polarized light by changing the phase of the incoming laser beam by a quarter-wavelength. The laser beam outgoing from the laser diode is converted by the quarter-wavelength plate from an S-polarized light to a circularly-polarized light on the path toward the optical disc and from a circularly-polarized light to a P-polarized light on the path back from the optical disc to the photodetector.

The rise-up mirror, disposed at a position where the laser beam transmitted through the quarter-wavelength plate enters, is configured to reflect an incoming laser beam in the direction of the object lens.

The object lens, by its condensing function, irradiates the incoming laser beam to a spot on a signal recording layer provided to the optical disc.

The laser beam irradiated on the signal recording layer is reflected by the signal recording layer.

The light reflected by the signal recording layer of the optical disc enters the control film of the semitransparent mirror by way of the object lens, the rise-up mirror, the quarter-wavelength plate, and the collimator lens.

This reflected light, which has been changed from a circularly-polarized light to a linearly-polarized light in the P direction by the phase changing function of the quarter-wavelength plate, is transmitted through the control film. The reflected light transmitted through the control film enters the AS plate.

The AS plate, arranged to incline relative to the direction of the light axis of the reflected light, adds to the reflected light the astigmatism to be used for focusing control.

The photodetector, configured to include light receiving units that respectively receive three beams into which the reflected light is separated by the diffraction grating, generates a reproducing signal to read out information recorded on the signal recording layer of the optical disc, a focus error signal to perform focusing control, and a tracking error signal to perform tracking control.

Such an optical pickup apparatus is disclosed in, for example, Japanese Laid-Open Patent Publication No. 1997-204681.

In this way, the optical pickup apparatus generates a signal for reproducing information recorded on the optical disc, a focus error signal, and a tracking error signal by reflecting with the signal recording layer of the optical disc the laser beam outgoing from the laser diode and detecting the reflected light with the photodetector.

Here, a control film that enhances transmittance of P-polarized light is formed on the surface of the AS plate, giving priority to transmittance to avoid the light volume of the reflected light received by the photodetector from decreasing. Further, a control film is formed on the surface of the AS plate to keep the transmittance of the P-polarized light and the S-polarized light constant within a predetermined wavelength range so that the transmittance of the laser beam does not fluctuate even if the wavelength of the laser beam radiated from the laser diode varies due to changes in temperature of the laser diode. The control film formed is so designed that, for example, the transmittance of the P-polarized light is 97% or more and at the same time, remains constant within the wavelength range taking into account the wavelength of the laser beam to be used and the laser beam wavelength fluctuation range plus margins.

However, due to differences in manufacturing technology, etc., some optical discs cause double refraction exceeding that permissible when the laser beam passes through the cover layer covering the signal layer.

When a laser beam is irradiated on such an optical disc that causes double refraction, the reflected light transmitted through the semitransparent mirror to enter the AS plate has the P-polarization component decreased and the S-polarization component increased since the balance of the polarization components of the reflected light from the optical disc change or vary.

In this case, when transmittance of the S-polarization component in the AS plate is relatively low as compared with that of the P-polarization component, the light volume of the reflected light transmitting through the AS plate decreases as a whole. For this reason, variations in double refraction of the optical disc causes large fluctuation in light volume of the reflected light to be received by the photodetector, resulting in reduced reliability of the reproduced signal, the focus error signal, and the tracking error signal.

### SUMMARY OF THE INVENTION

An optical pickup apparatus according to an aspect of the present invention, includes: a laser light source configured to emit a laser beam; an object lens configured to irradiate an optical recording medium with the laser beam; a photodetector configured to receive a reflected light of the laser beam reflected by the optical recording medium; a semitransparent mirror interposed on an optical path between the laser light source and the object lens, the semitransparent mirror configured to reflect the laser beam in a direction of the object lens and transmit the reflected light in a direction of the photodetector; and an astigmatism adding member interposed on an optical path between the semitransparent mirror and the photodetector, the astigmatism adding member configured to add astigmatism to the reflected light, wherein the astigmatism adding member includes a control film having a first transmittance for a polarization component in a first direction contained in the reflected light and a second transmittance for a polarization component in a second direction perpendicular to the first direction contained in the reflected light, the two transmittances are substantially equal to each other.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a perspective view of an optical pickup apparatus of the present embodiment;

FIG. 2 is a schematic diagram of a configuration example of a photodetector of the present embodiment;

FIG. 3 is a cross-sectional view of an AS plate of the present embodiment;

FIG. 4 is a table indicating transmittance of a laser beam in the AS plate of the present embodiment; and

FIG. 5 is a cross-sectional view of the AS plate of the present embodiment.

### DETAILED DESCRIPTION OF THE INVENTION

At least the following details will become apparent from descriptions of this specification and of the accompanying drawings.

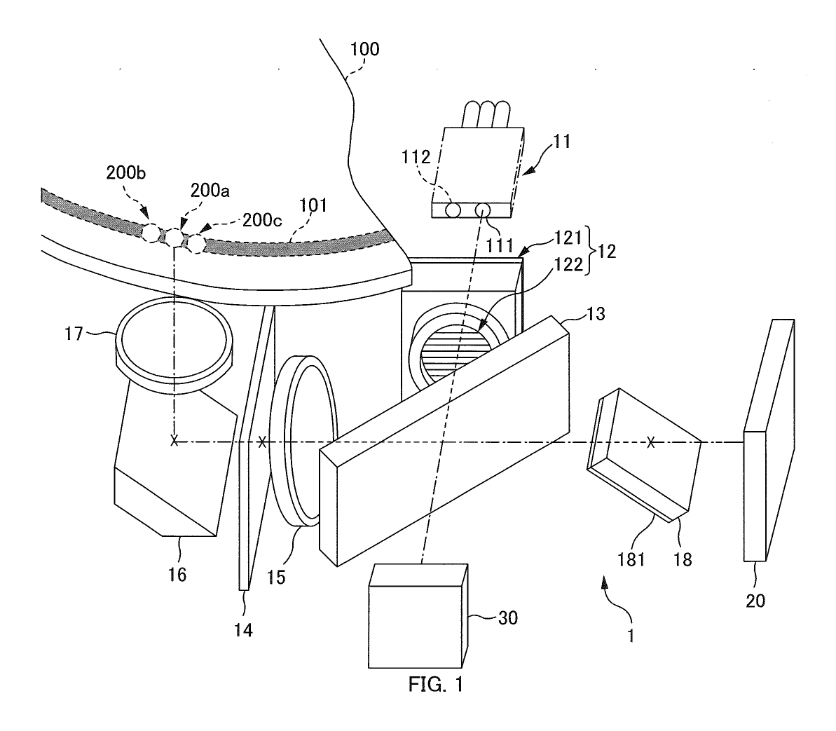

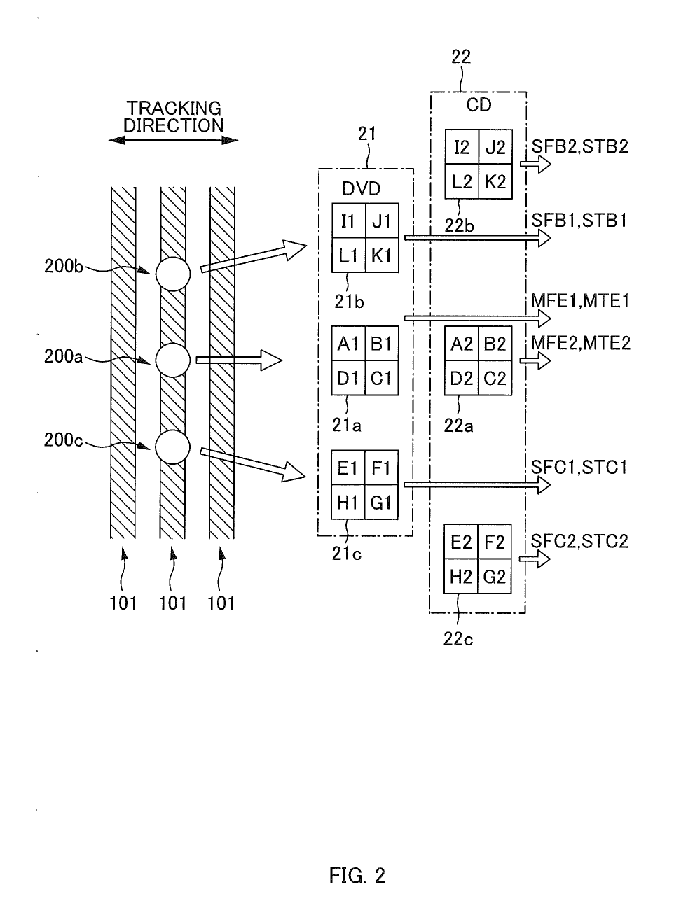

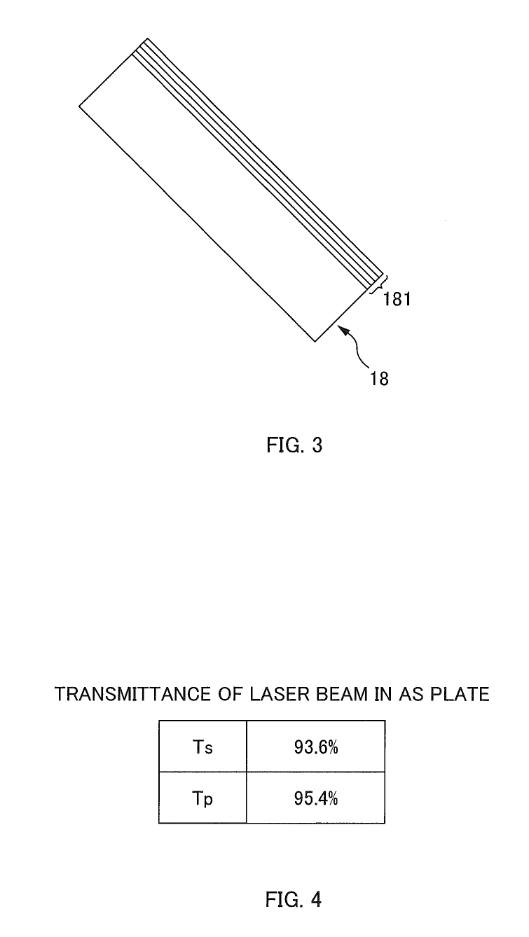

A configuration example will now be described of an optical pickup apparatus 1 of the present embodiment with reference to FIGS. 1 to 3. FIG. 1 is a perspective view of the optical pickup apparatus 1 of the present embodiment. FIG. 2 is a schematic diagram of a configuration example of a photodetector 20 of the present embodiment. FIG. 3 is a cross-sectional view of an AS (AStigmatism) plate (astigmatism adding member) 18 of the present embodiment.

The optical pickup apparatus 1 of the present embodiment is configured to handle recording and reproducing a DVD (Digital Versatile Disc) as well as handle recording and reproducing a CD (Compact Disc).

The laser unit 11 includes a first laser light source 111 that emits a laser beam of a first wavelength in 645 nm-to-675 nm red wavelength band suitable for recording and reproducing a DVD, for example, of a first wavelength of 660 nm (hereinafter referred to also as a first laser beam) and a second laser light source 112 that emits a laser beam of a second wavelength in 765 nm-to-805 nm infrared wavelength band suitable for recording and reproducing a CD, for example, of a second wavelength of 784 nm (hereinafter referred to also as a second laser beam).

The laser unit 11 is a so-called multi-laser unit and has the first laser light source 111 and the second laser light source 112 formed on the same semiconductor substrate.

The laser unit 11 selectively outputs the first laser beam or the second laser beam from the first laser light source 111 or the second laser light source 112. The first laser beam or the second laser beam output from the laser unit 11 enters a complex optical element 12.

The complex optical element 12 includes a half-wavelength plate 121 that converts the incoming laser beam to, for example, a linearly-polarized light of the direction rotated by substantially 45 degrees (first direction) relative to the direction of inclination of the reflection plane of a semitransparent mirror 13 and a diffraction grating 122 that separates the laser beam into three beams of a 0-order diffracted beam, a +1-order diffracted beam, and a −1-order diffracted beam. The half-wavelength plate 121 has a function of suppressing the reflected light of the laser beam reflected by the optical disc 100 to return to the laser unit 11.

The laser beam after passing through the complex optical element 12 has a part thereof reflected by the plate-type semitransparent mirror 13 arranged with a tilt, for example, 45 degrees relative to the laser beam and guided to a collimator lens 15, and has the remaining part thereof transmitted through the semitransparent mirror 13 and guided to the front monitor photodetector 30.

The semitransparent mirror 13 reflects a part, for example, 90% or 90% and more, of the laser beam of the linearly-polarized light in the first direction and transmits therethrough a part of the remainder, for example, 10% or 10% and less.

Therefore, almost all of the laser beam incoming from the diffraction grating 122 is reflected by the semitransparent mirror 13 to be guided to the collimator lens 15 and the remaining is transmitted through the semitransparent mirror 13 to be guided to the front monitor photodetector 30.

The intensity of the laser beam irradiated on the front monitor photodetector 30 changes according to the output level of the laser beam radiated from the laser unit 11. Accordingly, with the front monitor photodetector 30 feeding back a monitoring signal generated according to the intensity of the laser beam irradiated on the front monitor photodetector 30, to a drive circuit disposed to supply a drive signal to the laser unit 11, a laser servo operation can be performed to control the output of the laser beam radiated from the laser unit 11 to be brought to a target value.

The collimator lens 15 converts the laser beam of the first wavelength suitable for DVDs to a parallel light and narrows the angle of divergence of the laser beam of a second wavelength suitable for CDs. The laser beam after passing through the collimator lens 15 enters the quarter-wavelength plate 14.

The quarter-wavelength plate 14 converts the 0-order beam and the ⊥1-order diffracted beams reflected by the semitransparent mirror 13 from a linearly-polarized light of the first direction to a circularly-polarized light, on the outward path from the laser unit 11 to the optical disc 100 and at the same time, converts the reflected light from the optical disc 100 from a circularly-polarized light to a linearly-polarized light of a second direction orthogonal to the first direction, on the return path from the optical disc 100 to the photodetector 20.

Note that, with a combination of the semitransparent mirror 13 and the quarter-wavelength plate 14, the polarization state of the light, on the outward path and on the return path, is converted, for example, as follows:

On the outward path, the laser beam from the diffraction grating 122 has much of it reflected by the semitransparent mirror 13 and converted to, for example, a right turning circularly-polarized light by the quarter-wavelength plate 14.

The right turning circularly-polarized light, reflected by an information recording layer (not shown) of the optical disc 100, is changed to, for example, a left turning circularly-polarized light and is converted to a linearly-polarized light by the quarter-wavelength plate 14 on the return path. This linearly-polarized light has a part thereof transmitted through the semitransparent mirror 13.

The laser beam converted from a linearly-polarized light to a right turning circularly-polarized light by the quarter-wavelength plate 14, reflected by a rise-up reflective mirror 16, has its light axis bent into a light axis substantially perpendicular to the light axis of the laser beam output from the laser unit 11 as well as the light axis of the reflected light from the optical disc 100 received by the photodetector 20, to enters an object lens 17.

The object lens 17 has an annular diffraction structure formed with the light axis at its center on the incidence plane. The object lens 17, with the diffraction effect of this diffraction structure, appropriately corrects the spherical aberration caused by the thickness of the transparent substrate layer of each DVD and CD optical disc 100 when condensing the laser beam entering the object lens 17 on each DVD and CD optical disc 100.

The NA (Numerical Aperture) of the object lens 17 is designed to be 0.65 for the laser beam of the first wavelength suitable for DVDs and 0.51 for the laser beam of the second wavelength suitable for CDs.

For this reason, the laser beam of the first wavelength emitted from the first laser light source 111 is condensed to suit the thickness of the transparent substrate layer of the DVDs and irradiated on a signal layer of the DVDs by the object lens 17 and the laser beam of a second wavelength emitted from the second laser light source 112 is condensed to suit the thickness of the transparent substrate layer of the CDs and irradiated on the signal layer of the CDs by the object lens 17.

Such an optical system causes a laser beam of the first wavelength suitable for DVDs generated from the first laser light source 111 of the laser unit 11 to be condensed on the optical disc 100 of DVD standard and causes the laser beam of the second wavelength suitable for CDs generated from the second laser light source 112 of the laser unit 11 to be condensed on the optical disc 100 of CD standard.

The object lens 17 is configured to carry out focus control operation by displacement in a direction perpendicular to a signal face of the optical disc 100 (focusing direction) as well as carry out tracking control operation by the displacement in a radial direction of the optical disc 100 (tracking direction). The object lens 17 that carries out such operations is disposed in a manner capable of being displaced in the focusing direction and in the tracking direction by, for example, four or six support wires.

With the object lens 17 driven in the focusing direction and in the tracking direction, the laser beam is focused on the signal layer of a DVD or CD optical disc 100 as well as being irradiated on a signal track 101, so to follow the signal track.

The laser beam irradiated on the signal layer of the optical disc 100, modulated and reflected by the signal layer, returns to the object lens 17 and is converted from a circularly-polarized light to a linearly-polarized light by the quarter-wavelength plate 14. This laser beam of linear polarization has a part thereof, for example, on the order of 30%, transmitted through the semitransparent mirror 13.

The laser beam after transmitting through the semitransparent mirror 13 transmits through the AS plate 18 arranged with a tilt to add astigmatism used for focus control and thereafter guided to the photodetector 20. As shown in FIG. 3, a control film 181 is formed on the surface of the AS plate 18 to control the transmittance of the reflected light. Details of the control film 181 will be described later.

As shown in FIG. 2, the photodetector 20 has a DVD receiving area 21 to receive reflected light of the laser beam of a first wavelength suitable for DVDs and a CD receiving area 22 to receive reflected light of the laser beam of a second wavelength suitable for CDs formed on a same light receiving face, adjacent to each other.

A main beam receiving unit 21a, a front sub-beam receiving unit 21b, and a back sub-beam receiving unit 21c are formed in the DVD receiving area 21 to correspond to the three beams of the laser light of the first wavelength suitable for DVDs, namely, a main beam of 0-order light, a front sub-beam of +1-order diffracted light arranged in front of the main beam, and a back sub-beam of −1-order diffracted light arranged at the back of the main beam, respectively.

A main beam receiving unit 22a, a front sub-beam receiving unit 22b, and a back sub-beam receiving unit 22c are formed in the CD receiving area 22 to correspond to the three beams of the laser light of the second wavelength suitable for CDs, namely, the main beam of 0-order light, the front sub-beam of +1-order diffracted light arranged in front of the main beam, and the back sub-beam of −1-order diffracted light arranged at the back of the main beam, respectively.

The distance between the beam receiving units 21a, 21b, and 21c of the DVD receiving area 21 corresponds to the spaces between the beam spots when the reflected lights of the three beams of the laser light of the first wavelength are irradiated on the DVD receiving area 21.

The distance between the beam receiving units 22a, 22b, and 22c of the CD receiving area 22 corresponds to the spaces between the beam spots when the reflected lights of the three beams of the laser light of the second wavelength are irradiated on the CD receiving area 22.

In the photodetector 20, each of the main beam receiving unit 21a, the front sub-beam receiving unit 21b, and the back sub-beam receiving unit 21c of the DVD receiving area 21 and the main beam receiving unit 22a, the front sub-beam receiving unit 22b, and the back sub-beam receiving unit 22c of the CD receiving area 22 are divided into four parts by a crisscrossing line so that each of the units are composed of four segments.

The shape of the beam spot at which light is received by each of the main beam receiving unit 21a, the front sub-beam receiving unit 21b, and the back sub-beam receiving unit 21c of the DVD receiving area 21 changes according to a focus error and a tracking error when the first laser beam output from the laser unit 11 is irradiated on the optical disc 100.

The shape of the beam spot at which light is received by each of the main beam receiving unit 22a, the front sub-beam receiving unit 22b, and the back sub-beam receiving unit 22c of the CD receiving area 22 changes according to the focus error and the tracking error when the second laser beam output from the laser unit 11 is irradiated on the optical disc 100.

For this reason, the outputs of each light received by each of the segments constituting the main beam receiving unit 21a, the front sub-beam receiving unit 21b, and the back sub-beam receiving unit 21c of the DVD receiving area 21 are calculated based on a predetermined equation to obtain a reproducing signal, a focus error signal, and a tracking error signal at the time of recording and reproducing a DVD.

Likewise, the outputs of each light received by each of the segments constituting the main beam receiving unit 22a, the front sub-beam receiving unit 22b, and the back sub-beam receiving unit 22c of the CD receiving area 22 are calculated based on the predetermined equation to obtain the reproducing signal, the focus error signal, and the tracking error signal at the time of recording and reproducing a CD.

The reproducing signal of a DVD can be obtained by adding the signals output from sensors A1, B1, C1, and D1 constituting the main beam receiving unit 21a according to the light volume of the main beam irradiated on the main beam receiving unit 21a. The reproducing signal of a CD can be obtained by adding the signals output from sensors A2, B2, C2, and D2 constituting the main beam receiving unit 22a according to the light volume of the main beam irradiated on the main beam receiving unit 22a.

The focus error signal of a DVD can be obtained, for example, by using a differential astigmatism method, as follows:

Firstly, two added signals are obtained by adding signals of the sensors in diagonal relationships among the signals output, from the sensors I1, J1, K1, and L1 composing the front sub-beam receiving unit 21b, according to the light volume of the front sub-beam irradiated on the front sub-beam receiving unit 21b. Then a signal SFB1 is obtained by subtracting one added signal from the other added signal.

Likewise, two added signals are obtained by adding signals of the sensors in diagonal relationships among the signals output, from the sensors E1, F1, G1, and H1 composing the back sub-beam receiving unit 21c, according to the light volume of the back sub-beam irradiated on the back sub-beam receiving unit 21c. Then a signal SFC1 is obtained by subtracting one added signal from the other added signal.

Then a sub-focus error signal SFE1 is obtained by adding signal SFB1 and signal SFC1.

Further, two added signals are obtained by adding signals of the sensors in diagonal relationships among the signals, output from the sensors A1, B1, C1, and D1 composing the main beam receiving unit 21a, according to the light volume of the main beam irradiated on the main beam receiving unit 21a. Then a main focus error signal MFE1 is obtained by subtracting one added signal from the other added signal.

Focus error signal FE1 is generated by an arithmetic operation using the sub-focus error signal SFE1 and the main focus error signal MFE1.

Specifically, with regard to the operation for generating the focus error signal FE1, with reference to the reference numerals of the sensors shown in FIG. 2, the main focus error signal MFE1 can be expressed as MFE1=(A1+C1)−(B1+D1) and the sub-focus error signal SFE1 as SFE1={(E1+G1)−(F1+H1)}+{(I1+K1)−(J1+L1)}.

And the focus error signal FE1 based on which the focusing control operation is performed in the above differential astigmatism method, can be obtained as FE1=MFE1−k1×SFE1, where k1 is a constant determined based on the light intensity of the main beam and the light intensity of the sub-beam.

Likewise, the focus error signal of CDs can be obtained by using the differential astigmatism method.

The tracking error signal of DVDs can be obtained by, for example, using a differential push-pull method in the following manner.

Firstly, two subtracted signals are obtained by performing subtraction with the sensors in diagonal relationships among the signals output, from the sensors I1, J1, K1, and L1 composing the front sub-beam receiving unit 21b, according to the light volume of the front sub-beam irradiated on the front sub-beam receiving unit 21b. Then these two subtracted signals are added to obtain a signal STB1.

Likewise, two subtracted signals are obtained by performing subtraction with the sensors in diagonal relationships among the signals output, from the sensors E1, F1, G1, and H1 composing the back sub-beam receiving unit 21c, according to the light volume of the back sub-beam irradiated on the back sub-beam receiving unit 21c. Then these two subtracted signals are added to obtain a signal STC1.

Then a sub-tracking error signal STE1 is obtained by adding signal STB1 and signal STC1.

Further, two subtracted signals are obtained by performing subtraction with the sensors in diagonal relationships among the signals output, from the sensors A1, B1, C1, and D1 composing the main beam receiving unit 21a, according to the light volume of the main beam irradiated on the main beam receiving unit 21a. Then these two subtracted signals are added to obtain a main tracking error signal MTE1.

Tracking error signal TE1 is generated by an arithmetic operation using the sub-tracking error signal STE1 and the main tracking error signal MTE1.

Specifically, with regard to the operation for generating the tracking error signal TE1, with reference to the reference numerals of the sensors shown in FIG. 2, the main tracking error signal MTE1 can be expressed as MTE1=(A1−C1)+(B1−D1) and the sub-tracking error signal STE1 as STE1={(E1−G1)+(F1−H1)}+{(I1−K1)+(J1−L1)}.

And the tracking error signal TE1 based on which the tracking control operation is performed in the above differential push-pull method, can be obtained as TE1=MTE1−k2×STE1, where k2 is a constant determined based on the light intensity of the main beam and the light intensity of the sub-beam.

Likewise, the tracking error signal of CDs can be obtained by using the differential push-pull method.

Since the reproducing signal, the focus error signal, and the tracking error signal of the optical disc 100 are generated based on the light volume irradiated on each segment of a sensor divided into four sections possessed by each of the beam receiving units 21a, 21b, 21c, 22a, 22b, and 22c of the photodetector 20, it is preferable to have as much light volume as possible of the reflected light irradiated on the photodetector 20 from the viewpoint of enhancing the performance of the optical pickup apparatus 1.

Incidentally, due to differences in manufacturing technology, etc., there are optical discs 100 that cause double refraction in excess of that permissible, when the laser beam passes through the cover layer covering the signal layer. When a laser beam is irradiated on such an optical disc 100 that causes double refraction, a change occurs in the polarization components of the reflected light from the optical disc 100.

For this reason, the ratio of the P-polarization component and the S-polarization component of the reflected light transmitted through the semitransparent mirror 13 and entering the AS plate 18, which is dependent on double refraction characteristics possessed by the optical disc 100, changes in various ways depending on the characteristics of the optical disc 100 being an object of signal reproduction.

Therefore, the AS plate 18 according to the present embodiment has a control film 181 formed so that transmittance Ts (first transmittance) of the S-polarization component and transmittance Tp (second transmittance) of the P-polarized component is about equal, as shown in FIG. 4. In the example of FIG. 4, the control film 181 is formed so that Ts equals 93.6% and Tp equals 95.4%.

In this way, since the optical pickup apparatus 1 according to the present embodiment has the control film 181 of the AS plate 18 formed so that the transmittance Tp of the P-polarized component is about equal to the transmittance Ts of the S-polarization component, reduction of the reflected light entering the photodetector 20 can be suppressed without changing the total light volume transmitted through the AS plate 18 even if the balance of the polarization components contained in the reflected light entering the AS plate 18 changes.

In particular, with the difference between the transmittances Tp and Ts of the P-polarization component and the S-polarization component, respectively, set smaller than 2% as in the present embodiment, effects from changes in the balance of the polarization components contained in the reflected light entering the AS plate 18 can be avoided.

The AS plate has been given priority to transmittance in order to prevent reduction of the light volume of the reflected light received by the photodetector or had the control film formed so that the transmittance of the P-polarized light and S-polarized light becomes constant within a predetermined wavelength range thus preventing the transmittance of the laser beam from fluctuating even when the wavelength of the laser beam radiated from the laser diode fluctuates due to variation in temperature of the laser diode. However, in the case of an AS plate as above, there was a difference of more than 10% between transmittances Tp and Ts of the P-polarization component and the S-polarization component, respectively. For example, an AS plate with transmittance Tp equal to 97.9% and transmittance Ts equal to 78.8% was used.

In the present invention, the difference between transmittances Tp and Ts of the P-polarization component and the S-polarization component, respectively, of the AS plate is set to less than 10% at minimum and, the effects from the light volume of the reflected light received by the photodetector fluctuating due to variation in double refraction of optical discs is expected to contribute little when the difference is set to less than 5%.

Therefore, the reproduction signal, the focus error signal, and the tracking error signal can be surely generated based on the light reflected by the optical disc 100 thus allowing to improve the efficiency and reliability of the optical pickup apparatus 1.

And, the light quantity of the reflected light irradiated on the photodetector 20 is avoided from reducing even in the case of reproducing an optical disc 100 of low quality that would cause strong double refraction when reflecting the laser beam, so that even optical discs 100 of low quality can be reproduced that had conventionally been difficult to do so.

Note that the AS plate 18, by way of example, uses white sheet glass (e.g., trade name: B270 (SCHOTT AG)) as structural material of the base material and has the control film 181 composed of a multilayer film with Tio2 and Sio2 laminated alternately.

The control film 181 of the AS plate can have the difference between the transmittance Tp of the P-polarization component and the transmittance Ts of the S-polarization component easily set to less than 10% after maintaining the overall transmittance by setting the transmittance Ts of the S-polarization component that is lower than that of the P-polarization component to 90% or greater. Thereafter, the transmittance of the AS plate 18 is adjusted by changing the thickness of each layer, the number of layers, or by changing the refraction index by varying the structural material of the control film 181.

The control film 181 can be formed, for example, by a thin film fabrication technology by vacuum evaporation method or sputtering method using physical vapor deposition (PVD) or can be formed by thin film fabrication technology by chemical vapor deposition (CVD).

For forming the control film 181, a method of applying coating material and applying thermal treatment thereto, and a method of bonding film on a surface of the base material of the AS plate are also conceivable.

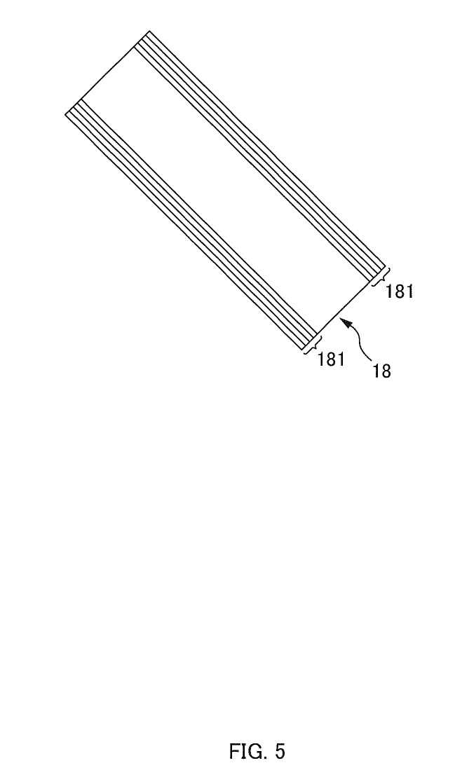

The control film 181 may be formed on one face of the base material as shown in FIG. 3 or may be formed on both faces thereof as shown in FIG. 5.

The control film 181 formed on one face of the base material enhances ease in manufacturing and thus allows to manufacture at low cost an AS plate 18 of high efficiency insusceptible to change of the polarization components of the reflected light.

The control film 181 formed on both faces of the base material can prevent reflected light from diffusing in both cases where the reflected light enters the AS plate 18 and where the reflected light exits the AS plate 18. Therefore allows to manufacture an AS plate 18 of high efficiency having higher transmittance and being insusceptible to change of the polarization components of the reflected light.

While an example of the optical pickup apparatus 1 of the present embodiment has been shown using a two-wavelength multi-laser unit, a single-wavelength single laser unit may be used. Moreover, a configuration using a three-wavelength multi-laser unit may be employed.

The present invention is not limited to an optical pickup apparatus compatible with DVDs and CDs but can also be used in optical pickup apparatuses conforming to Blu-ray Disc (registered trademark) standard using blue-violet laser beam (e.g., 405 nm) within a wavelength band of 400 nm-to-420 nm.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. An optical pickup apparatus comprising:
a laser light source configured to emit a laser beam;
an object lens configured to irradiate an optical recording medium with the laser beam;
a photodetector configured to receive a reflected light of the laser beam reflected by the optical recording medium;
a semitransparent mirror interposed on an optical path between the laser light source and the object lens, the semitransparent mirror configured to reflect the laser beam in a direction of the object lens and transmit the reflected light in a direction of the photodetector; and
an astigmatism adding member interposed on an optical path between the semitransparent mirror and the photodetector, the astigmatism adding member configured to add astigmatism to the reflected light, wherein
the astigmatism adding member includes a control film having a first transmittance for a polarization component in a first direction contained in the reflected light and a second transmittance for a polarization component in a second direction perpendicular to the first direction contained in the reflected light, the two transmittances are substantially equal to each other.

2. The optical pickup apparatus of claim 1, wherein
the control film is formed on either an incidence surface into which the reflected light is allowed to enter the astigmatism adding member or an exit surface from which the reflected light is allowed to exit the astigmatism adding member.

3. The optical pickup apparatus of claim 1, wherein
the control film is formed on both an incidence surface into which the reflected light is allowed to enter the astigmatism adding member and an exit surface from which the reflected light is allowed to exit the astigmatism adding member.

4. The optical pickup apparatus of claim 1, wherein
the first transmittance and the second transmittance are different from each other by less than 5%.

5. The optical pickup apparatus of claim 1, wherein
both the first transmittance and the second transmittance are equal to 90% or greater.
